(19) United States
(12) Patent Application Publication
(10) Pub. No.: US 2023/0268832 A1
(43) Pub. Date: Aug. 24, 2023

(54) SWITCHING CONVERTER WITH DRIVE STRENGTH CONTROL

(71) Applicant: Texas Instruments Incorporated, Dallas, TX (US)

(72) Inventor: Liang Zhang, Beijing (CN)

(21) Appl. No.: 17/854,355

(22) Filed: Jun. 30, 2022

Related U.S. Application Data
(60) Provisional application No. 63/312,475, filed on Feb. 22, 2022.

(51) Int. Cl. H02M 3/157; H02M 1/32

(52) U.S. Cl. CPC H02M 3/157; H02M 1/327

(57) ABSTRACT

In a switching converter, a controller has a controller input and a controller output. The controller is configured to provide: a first mode signal at the controller output responsive to a first temperature signal at the controller input; and a second mode signal at the controller output responsive to a second temperature signal at the controller input. Drive circuitry has a drive input and a drive output. The drive input is coupled to the controller output. The drive circuitry is configured to provide: a first drive signal at the drive output responsive to the first mode signal; and a second drive signal at the drive output responsive to the second mode signal. A switch has a control terminal coupled to the drive output.

### CROSS-REFERENCE TO RELATED APPLICATION

This application claims priority to U.S. Provisional Patent Application No. 63/312,475 filed Feb. 22, 2022, which is incorporated herein by reference.

### TECHNICAL FIELD

This description relates generally to integrated circuits, and more particularly to a switching converter system with drive strength control.

### BACKGROUND

Power supplies and power converters are used in a variety of electronic systems. Electrical power is generally transmitted over long distances as an alternating current (AC) signal. The AC signal is divided and metered as desired for each business or home location, and is often converted to direct current (DC) for use with individual electronic devices or components. Modern electronic systems (such as mobile phones, personal computers, automobiles, lighting systems, industrial equipment) often employ devices or components that operate with different DC voltages. Accordingly, those systems benefit from different DC-DC converters or a DC-DC converter that supports a wide range of output voltages.

Various DC-DC converter topologies differ in their components, the amount of power handled, the input voltage(s), the output voltage(s), efficiency, reliability, size and/or other characteristics. Example topologies include buck converter, boost converter, buck boost converter, fly back converter, etc.

A DC-DC converter should survive under room temperature, under a high temperature such as 125° C., and under a low temperature such as −40° C. Normally, a driver strength provided by a driver to a switch of the DC-DC converter has a negative temperature coefficient, so the driver becomes faster when the junction temperature of the switches of the DC-DC converter is lower, which results in bigger bounce under a low temperature such as −40° C., and thereby increasing a risk of possible damage under the low temperature.

For example, to protect the device in a hard-short test under a low temperature (such as −40° C.), a driver of a switch (high-side switch or low-side switch) of the DC-DC device should be relatively slow. But under a heavy load condition with higher junction temperature (such as 80° C.) of high-side or low-side switches (which are power FETs), the slower driver results in undesirable lower efficiency.

### SUMMARY

In a switching converter, a controller has a controller input and a controller output. The controller is configured to provide: a first mode signal at the controller output responsive to a first temperature signal at the controller input; and a second mode signal at the controller output responsive to a second temperature signal at the controller input. Drive circuitry has a drive input and a drive output. The drive input is coupled to the controller output. The drive circuitry is configured to provide: a first drive signal at the drive output responsive to the first mode signal; and a second drive signal at the drive output responsive to the second mode signal. A switch has a control terminal coupled to the drive output.

### BRIEF DESCRIPTION OF THE DRAWINGS

FIG. 1 is a block diagram of an electronic system in some examples.

FIGS. 2A and 2B are example circuit diagrams of a bandgap voltage generator.

FIG. 3 is a diagram of changing of a sensed voltage with changing temperature.

FIG. 4 is a diagram of ringing at a switching terminal under different temperatures.

FIG. 5 is a diagram of thermal performance when a DC-DC converter is under a full load condition.

FIGS. 6A and 6B are timing diagrams of voltage waveforms at the switching terminal in some examples.

FIG. 7 is a schematic diagram of an electronic system in some examples.

FIG. 8 is a diagram of a comparison of drive strength, with and without temperature detection.

FIG. 9 is a chart of efficiency as a function of loading in some examples.

FIG. 10 is a flowchart of a switching converter control method in some examples.

### DETAILED DESCRIPTION

Described herein are switching converter topologies with multiple drive stages and drive modes. A switching converter includes switch circuitry and multiple drive stages coupled to the switch circuitry, where the switch circuitry includes at least one switch and a switching terminal. In one example, with the described switching converter topologies, the switching converter adjusts its operations based on a temperature thereof. The switching converter is usually in the form of a semiconductor device. If a size of the semiconductor device is small enough, then a temperature of the semiconductor device is substantially equal to a junction temperature of the at least one switch of the switching converter.

In one example, if a voltage representative of the temperature of the device provided by a temperature sensor is greater than a reference voltage representative of a threshold temperature level, then a first set of drive stages of the multiple drive stages provides a first drive signal to the switch circuitry to drive a high-side switch or a low-side switch. The threshold temperature level is set based on a breakdown voltage of the at least one switch. When the first number of drive stages of the multiple drive stages provides a first drive signal to the switch circuitry, a switching slew rate of the at least one switch is increased, which increases the efficiency of the switching converter and increases ringing at the switching terminal. Because the temperature of the device is greater than or equal to the threshold temperature level, the increase of the switching slew rate is limited by the temperature, and such ringing will not exceed a maximum voltage target (such as a breakdown voltage of at least one transistor of a switching converter). In contrast, if the voltage representative of the temperature of the device is less than the reference voltage, then a second number of drive stages of the multiple drive stages provides a second drive signal to the switch circuitry to drive a high-side switch or a low-side switch, in which the second number is smaller than the first number. When the second number of drive stages provides the second drive signal to the switch circuitry, the switching slew rate is reduced, which reduces the efficiency of the switching converter and reduces ringing at the switching terminal.

In some examples, a switching converter includes a controller that supports multiple modes, where the modes are selected based on the voltage representative of the temperature of the switching converter. For example, if the output of the temperature sensor indicates the temperature of the switching converter is lower than the threshold temperature level, the controller is configured to select a first drive mode that uses only one of a first drive stage and a second drive stage to provide a first drive signal to the switch circuitry. In contrast, if the output of the temperature sensor indicates the temperature of the switching converter is higher than or equal to the threshold temperature level, the controller is configured to select a second drive mode that uses both of the first drive stage and the second drive stage to provide a second drive signal to the switch circuitry. In some examples, the controller includes the temperature sensor circuit and a level shifter, where the level shifter is coupled between the supply voltage detector circuit and the second drive stage.

In some examples, the first drive stage is configured to provide a first drive signal contribution to the switch circuitry, and the second drive stage is configured to provide a second drive signal contribution to the switch circuitry. The second drive signal contribution is larger than the first drive signal contribution. The controller may support additional modes (e.g., only the first drive stage is used, only the second drive stage is used, both the first and the second drive stages are used). Also, in some examples, more than two drive stages are possible. With the switching converter topologies described herein, switching converter efficiency and ringing management are performed based on the temperature sensor circuit and the threshold temperature level. Various switching converter options and current monitor circuit options are described herein.

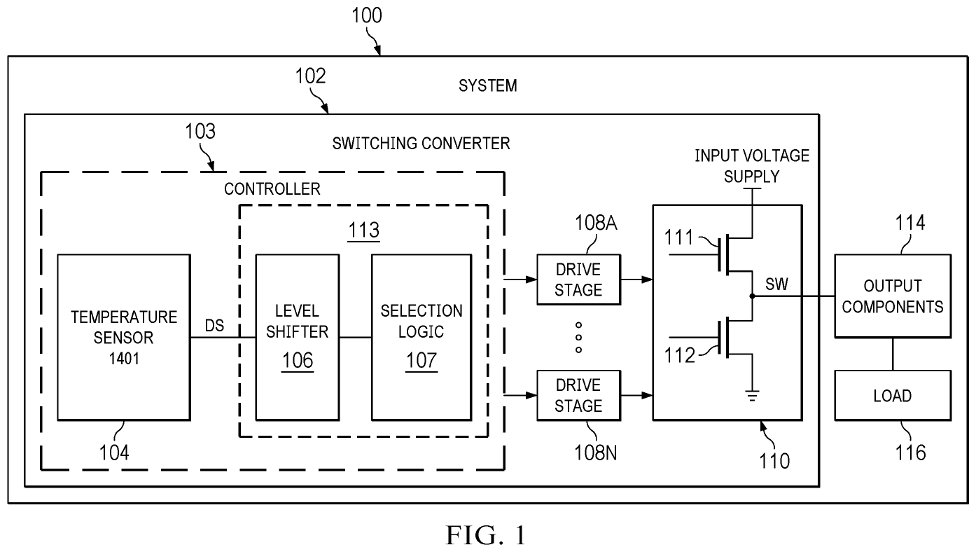

FIG. 1 is a block diagram of an electronic system 100 in some examples. The system 100 represents an integrated circuit (IC), a multi-die module (MDM), discrete components, or combinations thereof. In some examples, an IC, MDM and/or discrete components are coupled together using a printed circuit board (PCB). In one example, the electronic system 100 can be a mobile phone, a personal computer, an automobile, a lighting system, an industrial equipment, etc., which employs devices or components that operate at different DC voltages. As shown, the system 100 includes a switching converter 102 with drive stages 108A-108N coupled to switch circuitry 110. The switch circuitry 110 includes one or more switches and a switching terminal SW. In one example, the drive stages 108A-108N are coupled to a first switch (such as a high-side switch 111) of the switch circuitry 112, where each of the drive stages 108A-108N is configured to provide a respective drive signal contribution to the high-side switch 111. When the switching converter is a buck converter, the high-side switch 111 is coupled between an input voltage supply and the switching terminal SW. In another example, the drive stages 108A-108N are coupled to a second switch (such as a low-side switch 112) of the switch circuitry 110, where each of the drive stages 108A-108N is configured to provide a respective drive signal contribution to the low-side switch 112. The low-side switch 112 can be coupled between the switching terminal SW and ground. In some examples, drive signal contribution of each of the drive stages 108A-108N is equal to each other (e.g., 50% contribution for two drive signals, 25% contribution for four drive signals, etc.). In other examples, each drive signal contribution is different from each other (e.g., 60% and 40% contributions for two drive signals, etc.). In some examples, some of the drive stages 108A-108N are coupled to the high-side switch 111, while others of the drive stages 108A-108N are coupled to the low-side switch 112.

In the example of FIG. 1, the drive stages 108A-108N are coupled to a controller 103. The controller 103 is configured to control the drive stages 108A-108N based on a temperature of the switching converter 102. As shown, the controller 103 includes: a temperature detector 104 configured to detect the temperature of the switching converter 102 with respect to a threshold temperature and generate a detection signal DS; and control circuitry 113 configured to control the drive stages 108A-108N based on the detection signal DS. In some examples, the temperature detector 104 includes: a temperature sensor 1041 configured to generate a signal Vptat representative of the temperature of the switching converter 102; and one or more comparators configured to perform temperature detection based on the signal Vptat and a reference voltage VREF representative of the threshold temperature. In other examples, the temperature sensor 1041 is configured to measure the temperature of the switching converter 102.

Regardless of the particular temperature sensing mechanism, the temperature detector 104 is configured to provide the detection signal (DS) to indicate whether the temperature of the switching converter 102 is higher than or equal to the threshold temperature.

In one example, the temperature sensor 1041 is a part of a bandgap voltage generator of the switching converter 102 that generates a bandgap voltage of the switching converter 102.

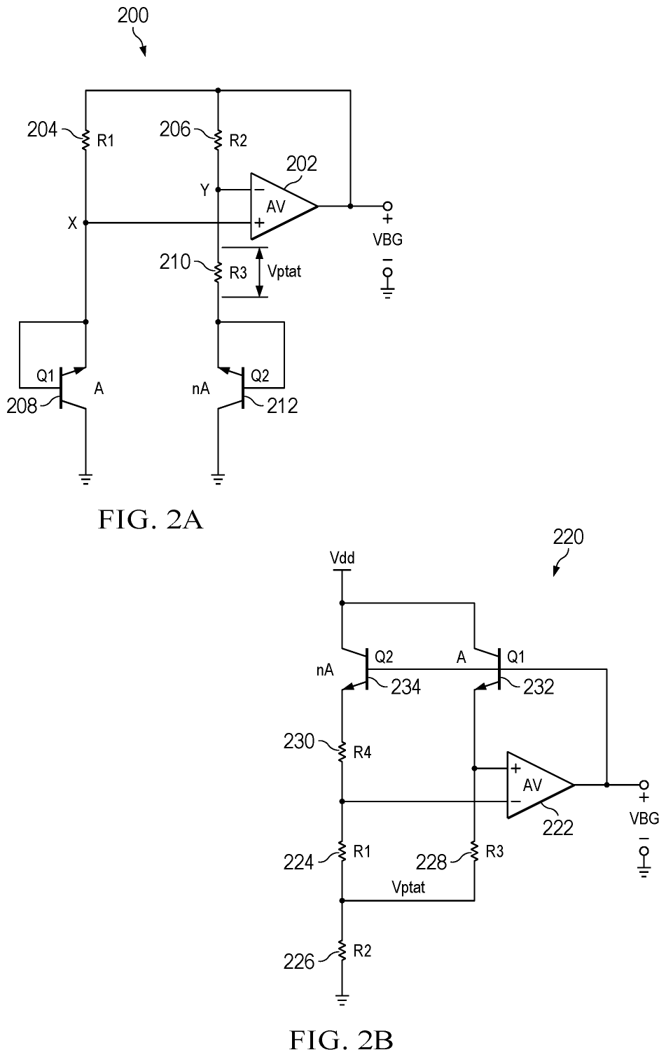

FIG. 2A shows an example of a circuit diagram of a bandgap voltage generator 200. The bandgap voltage generator 200 is configured to generate the bandgap voltage VBG of the switching converter 102. In the example of FIG. 2A, the bandgap voltage generator 200 includes an amplifier 202, a first resistor 204 coupled between a first input of the amplifier 202 and an output of the amplifier 202, a second resistor 206 coupled between a second input of the amplifier 202 and the output, a first transistor Q1 208 coupled between the first input and ground, a third resistor R3 210 and a second transistor Q2 212 coupled in series between the second input and ground. The output of the amplifier 202 is configured to provide the bandgap voltage VBG.

In one example, the first and second transistors 208 and 212 are bipolar junction transistors (BJTs) and have a negative temperature coefficient in the linear region. However, the first and second transistors 208 and 212 can also be field effect transistors (FETs). In one example, the signal Vptat is a voltage across the third resistor R3 210, representative of a difference between: a voltage between a base and an emitter of the first transistor Q1 208; and a voltage between a base and an emitter of the second transistor Q2 212, which increases with increase of the temperature. In another example, a voltage Vntat (which is proportional to the voltage between the base and emitter of the first transistor Q1 208, or the voltage between the base and emitter of the second transistor Q2 212, and which increases with reduction of the temperature) can also be provided for temperature detection.

FIG. 2B shows another example of a circuit diagram of a bandgap voltage generator 220. The bandgap voltage generator 220 is configured to generate the bandgap voltage VBG of the switching converter 102. In the example of FIG. 2B, the bandgap voltage generator 220 includes an amplifier 222, a first resistor 224 having a first terminal coupled to a first input of the amplifier 222 and having a second terminal, a second resistor 226 having a first terminal coupled to the second terminal of the first resistor 224 and having a second terminal coupled to ground, a third resistor 228 coupled between a second input of the amplifier 222 and the first terminal of the second resistor 226, and a fourth resistor 230 having a first terminal coupled to the first input of the amplifier 222 and having a second terminal. The bandgap voltage generator 220 further includes a first transistor Q1 232 and a second transistor Q2 234. The first transistor 232 includes a first current terminal coupled to the second input of the amplifier 222, a second current terminal coupled to a voltage supply terminal, and a control terminal coupled to an output of the amplifier 222. The second transistor 234 includes a first current terminal coupled to the second terminal of the fourth resistor 230, a second current terminal coupled to the voltage supply terminal, and a control terminal coupled to the output of the amplifier 222. The output of the amplifier 222 is configured to provide the bandgap voltage VBG.

In one example, the first and second transistors 232 and 234 are bipolar junction transistors (BJTs) and have a negative temperature coefficient in the linear region. However, the first and second transistors 232 and 234 can also be FETs. In one example, the signal Vptat is a voltage across the second resistor 226, representative of a difference between: a voltage between a base and an emitter of the first transistor 232; and a voltage between a base and an emitter of the second transistor 234, which increases with increase of the temperature. In the example of FIG. 2B, the signal Vptat is a voltage at the first terminal of the second resistor 226.

Referring again to FIG. 1, the temperature detector 104 generate the detection signal DS based on the signal Vptat. Other topologies of a bandgap generator that provides a Vptat or a Vntat proportional to the temperature are also applicable. By using the bandgap generator 200 to sense the temperature of the switching converter 102, no additional temperature sensor is needed for temperature sensing.

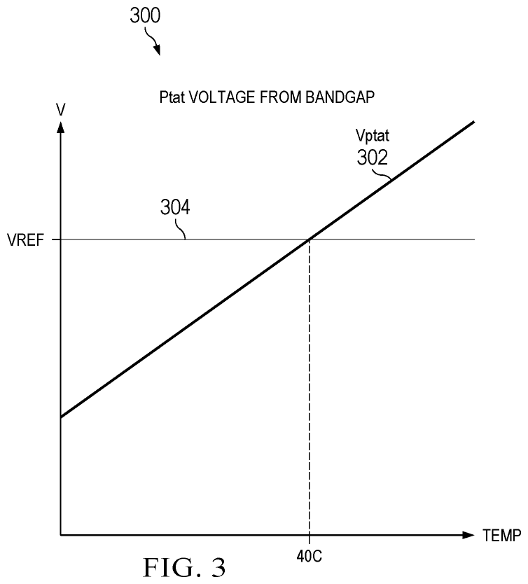

FIG. 3 is a chart 300 illustrating the increase of the signal Vptat 302 with increase of the temperature TEMP. In one example, the threshold temperature is set to 40° C., and the reference voltage VREF 304 is set based on a level of the signal Vptat 302 when the temperature is 40° C. In one example, the temperature detector 104 includes a comparator to compare the signal Vptat with the reference voltage VREF, and generate the detection signal DS.

Referring again to FIG. 1, in some examples, the controller 103 also includes a level shifter 106 configured to receive the detection signal DS from the temperature detector 104. The level shifter 106 is configured to adjust the detection signal DS to another voltage domain to enable selection logic 107 to control at least one of the drive stages 108A-108N. In the example of FIG. 1, the controller 103 supports multiple modes, where the modes are selected based on the detection signal DS. For example, if the detection signal DS indicates the temperature of the switching converter 102 is lower than the threshold temperature, the controller 103 is configured to select a first drive mode that uses a first number of drive stages of the drive stages 108A-108N to provide a first drive signal to the switch circuitry 110. In contrast, if the detection signal DS indicates the temperature of the switching converter 102 is higher than or equal to the threshold temperature, the controller 103 is configured to select a second drive mode that uses a second number of drive stages of the drive stages 108A-108N to provide a second drive signal to the switch circuitry 110, in which the second number is greater than the first number.

In one example, the switching converter 102 includes first and second drive stages. When the temperature is lower than a threshold temperature, the detection signal DS output from the temperature detector 104 is at a first state (such as logic low); and in response, the control circuitry 113 enables only the first stage of the two drive stages to provide a first drive signal to the switch circuitry 110. When the temperature is higher than or equal to the threshold temperature, the detection signal DS output from the temperature detector 104 is at a second state (such as logic high); and in response, the control circuitry 113 enables both of the first and second drive stages to provide a second drive signal to the switch circuitry 110.

In a buck converter example, the switching terminal SW is adapted to be coupled to an output inductor (e.g., one of the output components 114 for the system 100). In this example, the output components 114 also include an output capacitor, where charge stored by the output capacitor is provided to a load 116. In some examples, the controller 103 uses different modes to direct the drive stages 108A-108N to provide a drive signal to the high-side switch based on the temperature. In other examples, the controller 103 uses different modes to direct the drive stages 108A-108N to provide a drive signal to the low-side switch based on an input supply voltage level. In some examples, a first set of drive stages provides a high-side drive signal to the high-side switch based on the temperature, and a second set of drive stages provides a low-side drive signal to the low-side switch based on the temperature.

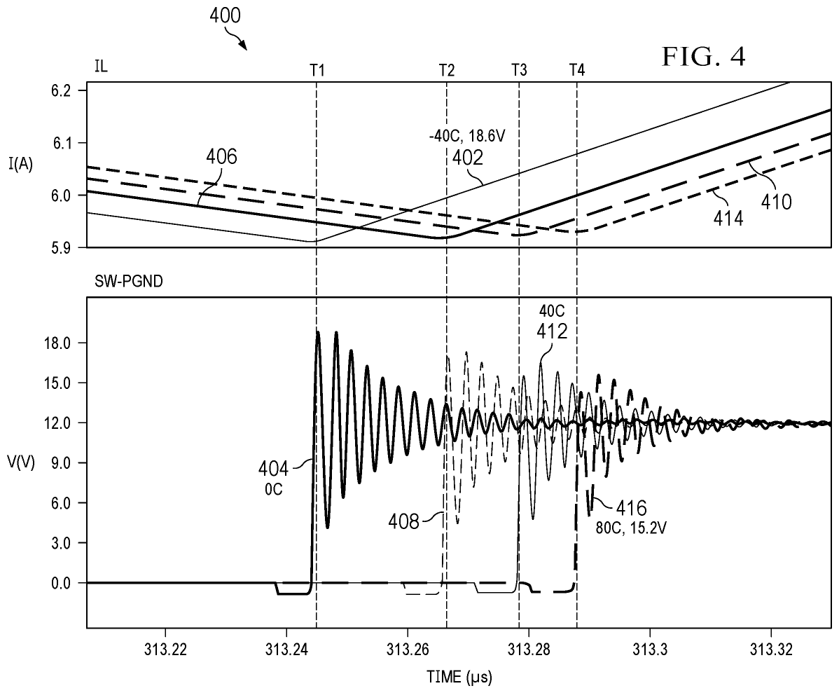

FIG. 4 is a chart 400 of ringing at the switching terminal of a switching converter with respect to ground under different temperatures, caused by a same drive signal. Waveform 402 depicts an inductor current IL when the temperature is −40° C., and waveform 404 depicts ringing at the switching terminal SW responsive to the high-side switch turning on at T1 when the temperature is −40° C. Waveform 406 depicts an inductor current IL when the temperature is 0° C., and waveform 408 depicts ringing at the switching terminal SW responsive to the high-side switch turning on at T2 when the temperature is 0° C. Waveform 410 depicts an inductor current IL when the temperature is 40° C., and waveform 412 depicts ringing at the switching terminal SW responsive to the high-side switch turning on at T3 when the temperature is 40° C. Waveform 414 depicts an inductor current IL when the temperature is 80° C., and waveform 416 depicts ringing at the switching terminal SW responsive to the high-side switch turning on at T4 when the temperature is 80° C. FIG. 4 shows that a lower temperature results in more ringing at the switching terminal when the high-side switch is turned from “off” to “on” indicated by the corresponding inductor current changing from reducing to increasing.

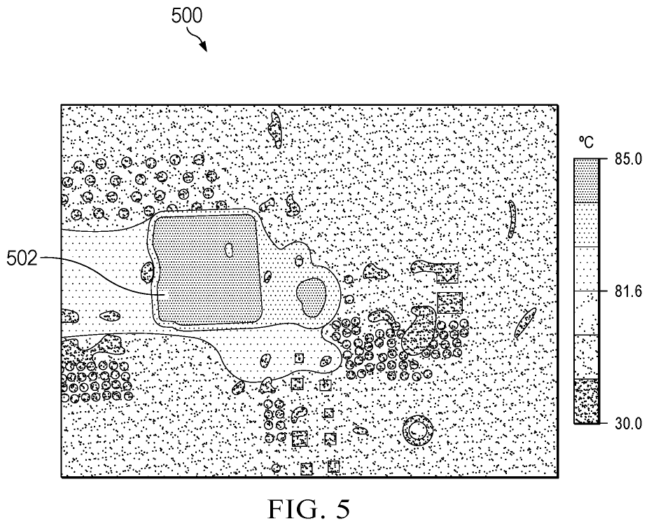

FIG. 5 is a heat map 500 of a device 502 of a switching converter after running under a heavy load condition for 15 minutes. The input voltage Vin of the switching converter is 12V, the output voltage of the switching converter is 5V, and the output current of the switching converter is 6 A. After 15 minutes running, the temperature of the device 502 can increase to above 80° C. In one example, for a switching converter having an output current of 3 A, the threshold temperature is set between 50° C. to 60° C. The threshold temperature can be obtained by tests to ensure that the ringing caused by the corresponding drive mode does not exceed the breakdown voltage of the high-side or low-side switches of the switching converter 102.

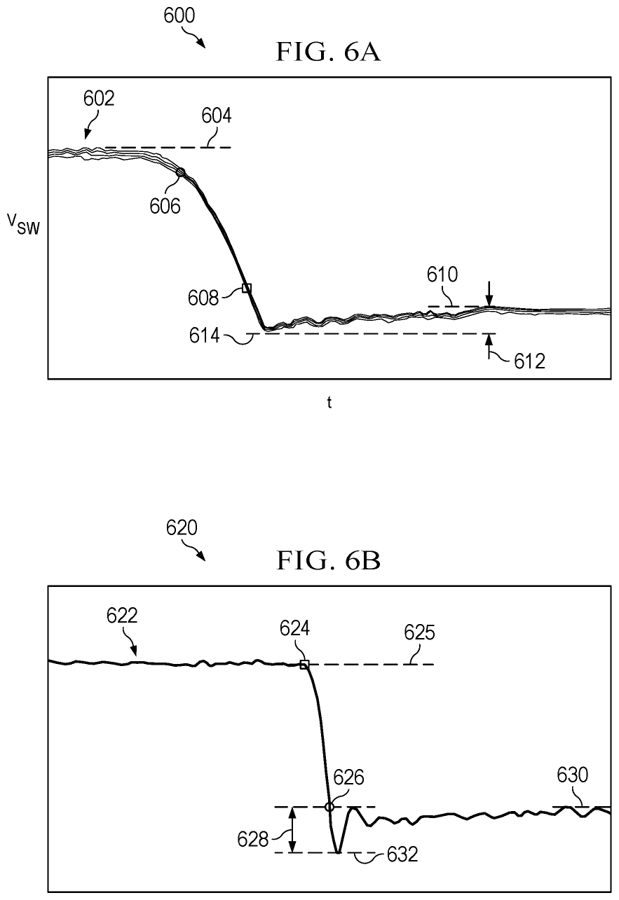

FIGS. 6A and 6B are timing diagrams of switching terminal voltage waveforms in some examples. In the timing diagram 600 of FIG. 6A, a switching terminal voltage waveform 602 is represented. As shown, the switching terminal voltage waveform 602 shows a falling edge scenario, where the switching terminal voltage drops from a high level 604 to a low level 610. In the example of FIG. 6A, the slew rate of the falling edge is measured as the change in voltage/change in time (dv/dt) from points 606 to 608. The switching terminal voltage waveform 602 also shows that the switching terminal voltage reaches a minimum value 614 with an offset 612 between the minimum value 614 and the low level 610. In the example of FIG. 6A, the slew rate for the switching terminal voltage is approximately 3V/ns. Such a slew rate reduces ringing issues, but results in inefficient switching operations (more switching losses compared to faster slew rates).

In the timing diagram 620 of FIG. 6B, another switching terminal voltage waveform 622 is represented. As shown, the switching terminal voltage waveform 622 shows a falling edge scenario, where the switching terminal voltage drops from a high level 625 to a low level 630. In the example of FIG. 6B, the slew rate of the falling edge is measured as the change in voltage/change in time (dv/dt) from points 624 to 626. The switching terminal voltage waveform 620 also shows that the switching terminal voltage reaches a minimum value 632 with an offset 628 between the minimum value 632 and the low level 630. In the example of FIG. 6B, the slew rate for the switching terminal voltage is approximately 10V/ns. Such a slew rate is more efficient (compared to the slew rate of the switch node voltage waveform 302), but increases ringing issues. For example, the offset 628 represented in FIG. 6B is larger than the offset 612 represented in FIG. 6A.

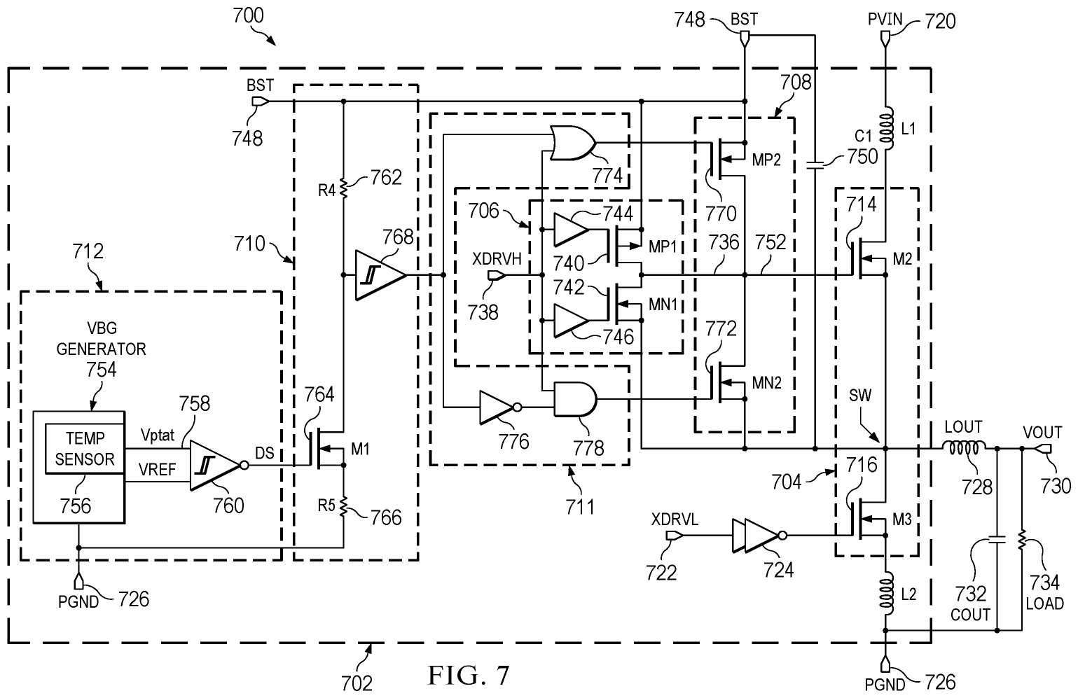

FIG. 7 is a schematic diagram of an electronic system 700 in some examples. As shown, the system 700 includes a switching converter 702 (an example of the switching converter 102 of FIG. 1) having a switch circuitry 704 (an example of the switch circuitry 110 of FIG. 1), first and second drive stages 706 and 708 (examples of the drive stages 108A-108N of FIG. 1), a level shifter 710 (an example of the level shifter 106 of FIG. 1), a selection logic 711 (an example of the selection logic 107 of FIG. 1), and a temperature detector 712 (an example of the temperature detector 104 of FIG. 1).

As shown in FIG. 7, the switch circuitry 704 includes a high-side switch 714 and a low-side switch 716 coupled at a switching terminal SW. In the example of FIG. 7, the high-side switch 714 includes a control terminal coupled to the first drive stage 706 and a second drive stage 708. A first current terminal of the high-side switch 714 is coupled to an input supply terminal 720, such as the input voltage supply of FIG. 1, via a first inductor L1, and a second current terminal of the high-side switch 714 and a first current terminal of the low-side switch 716 are coupled at the switching terminal SW. Also, a control terminal of the low-side switch 716 is coupled to a low-side drive signal (XDRVL) terminal 722 via buffers 724. A second current terminal of the low-side switch 716 is coupled to a ground terminal 726 via a second inductor L2. In the example of FIG. 7, the first inductor L1 and the second inductor L2 represent parasitic inductance (e.g. from a printed circuit board (PCB)), which is a consideration for driver design. The first inductor L1 and the second inductor L2 are not actual inductor components.

As shown, the switching terminal SW is also coupled to a first end of an output inductor 728. A second end of the output inductor 728 is coupled to an output terminal 730. As shown, the output terminal 730 is also coupled to a first terminal of an output capacitor 732. A second terminal of the output capacitor 732 is coupled to the ground terminal 726. In the example of FIG. 7, a load 734 is coupled between the output terminal 730 and the ground terminal 726, where the load 734 is powered by the output voltage VOUT at the output terminal 730. Comparing FIGS. 1 and 7, the output inductor 728 and the output capacitor 732 of FIG. 7 are examples of the output components 114, and the load 734 of FIG. 7 is an example of the load 116 of FIG. 1.

In operation, the first drive stage 706 is configured to provide a first drive signal 736 to the control terminal of the high-side switch 714 responsive to a high-side drive signal XDRVH at a high-side drive signal (XDRVH) terminal 738. More specifically, the first drive stage 706 includes first and second transistors 740 and 742, having their control terminals coupled to the high-side drive signal terminal 738 via respective buffers 744 and 746. Also, the first current terminal of the first transistor 740 is coupled to an input supply BST terminal 748. In some examples, BST is a power supply, which is about 5V higher than the switching terminal SW. In one example, the voltage level for BST is obtained by placing a capacitor 750 between the BST terminal 748 and the switching terminal SW. More specifically, a first (e.g., top) plate of the capacitor 750 is coupled to the BST terminal 748, and a second (e.g., bottom) plate of the capacitor 750 is coupled to the switching terminal SW.

A second current terminal of the first transistor 740 is coupled to a first current terminal of the second transistor 742, and a second current terminal of the second transistor 742 is coupled to the switching terminal SW. Responsive to the output voltage VOUT dropping below a threshold or another trigger, the high-side drive signal XDRVH transitions from logic high to logic low, which causes the first and second transistors 740 and 742 to provide the first drive signal 736 to turn on the high-side transistor 714 to increase the output voltage VOUT. After the output voltage VOUT reaches a threshold value or another trigger occurs, the high-side drive signal XDRVH transitions from logic low to logic high, which causes the first and second transistors 740 and 742 to stop providing the first drive signal 736, and results in the high-side switch 714 being turned off. In some examples, the first drive stage 706 is used in multiple drive modes.

In operation, the second drive stage 708 is configured to provide a second drive signal 752 to the control terminal of the high-side switch 714 responsive to a detection signal DS from the temperature detector 712 indicating that the temperature is higher than a threshold value. In one example, the temperature detector 712 includes: a comparator 760; and a temperature sensor 756, which is a part of a bandgap voltage generator 754 of the switching converter 702 that generates a bandgap voltage VBG. The temperature sensor 756 includes an output 758 to provide a voltage signal Vptat representative of the temperature of the switching converter 702. The output 758 of the temperature sensor 756 is coupled to one of the input terminals of the comparator 760. The other input terminal of the comparator 760 is configured to receive a reference voltage VREF, such as the reference voltage VREF of FIG. 3. In one example, the reference voltage VREF is generated based on the bandgap voltage VBG, and is representative of the threshold temperature. When the voltage Vptat is less than the reference voltage VREF, the detection signal DS at the output of the comparator 760 is logic low. Therefore, when the high-side drive signal XDRVH is low, and if the temperature of the switching converter 702 is lower than the threshold temperature, the second drive stage 708 is not used, and only the first drive stage 706 drives the high-side switch 714. In contrast, when the voltage Vptat is greater than or equal to the reference voltage VREF, the detection signal DS at the output of the comparator 760 is logic high. Therefore, when the high-side drive signal XDRVH is logic low, and if the temperature of the switching converter 702 is higher than or equal to the threshold temperature, both the first drive stage 706 and the second drive stage 708 drive the high-side switch 714.

As shown in FIG. 7, the output of the comparator 760 provides a control signal to the level shifter 710, which includes a fourth resistor 762, a control switch 764, and a fifth resistor R5 coupled in series between the BST terminal 748 and the ground terminal 726. A control terminal of the control switch 764 is coupled to the output of the comparator 760, the fifth resistor R5 is coupled between the BST terminal 748 and a first current terminal of the control switch 764, and the fifth resistor 766 is coupled between a second current terminal of the control switch 764 and the ground terminal 726. In the example of FIG. 7, component 768, such as a Schmitt comparator, adjusts the voltage level at the first current terminal of the control switch 764 to another voltage level.

As shown in FIG. 7, the second drive stage 708 includes third and fourth transistors 770 and 772, and the output of the component 768 is provided to an input terminal of an OR gate 774, where the output terminal of the OR gate is coupled to a control terminal of the third transistor 770. The other input terminal of the OR gate 774 is coupled to the high-side drive signal (XDRVH) terminal 738. The output of the component 768 is also coupled to an input of an inverter 776. An output of the inverter 776 is coupled to an input terminal of an AND gate 778. The other input terminal of the AND gate 778 is coupled to the high-side drive signal (XDRVH) terminal 738. The output terminal of the AND gate 778 is coupled to a control terminal of the fourth transistor 772.

In the first drive mode, only the first drive stage 706 is used. In some examples, the control of the first and second transistors 740 and 742 in the first drive mode is a function of the high-side drive signal XDRVH. More specifically, in the first drive mode (in which only the first drive stage 706 is used), when the high-side drive signal XDRVH is logic low, the second transistor 742 turns off, the first transistor 740 turns on, and the high-side switch 714 is turned on. In the first drive mode, the third transistor 770 will not be turned on if the output of the component 768 is logic high, which indicates the temperature of the switching converter 702 is lower than the threshold temperature. In contrast, in the first drive mode, when the high-side drive signal XDRVH is logic high, the second transistor 742 turns on, the first transistor 740 turns off, and the high-side switch 714 is turned off. In the first drive mode, the fourth transistor 772 will not be turned on if the output of the component 768 is logic high, which indicates the temperature is lower than the threshold temperature level.

In the second drive mode (in which both the first and second drive stages 706 and 708 are used), the control of the first through fourth transistors 740, 742, 770 and 772 is a function of the high-side drive signal XDRVH. More specifically, in the second drive mode, when the high-side drive signal XDRVH is logic low, the first transistor 740 is turned on, and the third transistor 770 is turned on if the output of the component 768 is logic low, which indicates the temperature is higher than or equal to the threshold temperature. Turning on the third transistor 770 causes the high-side switch 714 to turn on faster, which improves the efficiency of the switching converter 702. In the second drive mode, when the high-side drive signal XDRVH is logic high, the second transistor 742 is turned on, and the high-side switch 714 is turned off. The fourth transistor 772 is also turned on, which causes the high-side switch 714 to turn off faster.

In the example of FIG. 7, the operations of the switching converter 702 are adjusted based on the temperature. If the temperature is higher than or equal to the threshold temperature (detected by the temperature detector 712), both of the first and second drive stages 706 and 708 provide a drive signal to the high-side transistor 714. When both of the first and second drive stages 706 and 708 provide a drive signal to the high-side transistor 714, the switching slew rate is increased, which increases the efficiency of the switching converter 702 and increases switching terminal ringing. In contrast, if the temperature is lower than the threshold temperature, then only the first drive stage 706 provides a drive signal to the high-side switch 714. When only the first drive stage 706 provides the drive signal to the high-side switch 714, the switching slew rate is reduced, which reduces the efficiency of the switching converter 702 and also reduces switching terminal ringing. In one example, for a switching converter having a target output voltage of 17V, the threshold temperature is set around 40° C. to ensure that the ringing does not exceed a breakdown voltage of at least one of the high-side and low-side switches of the switching converter.

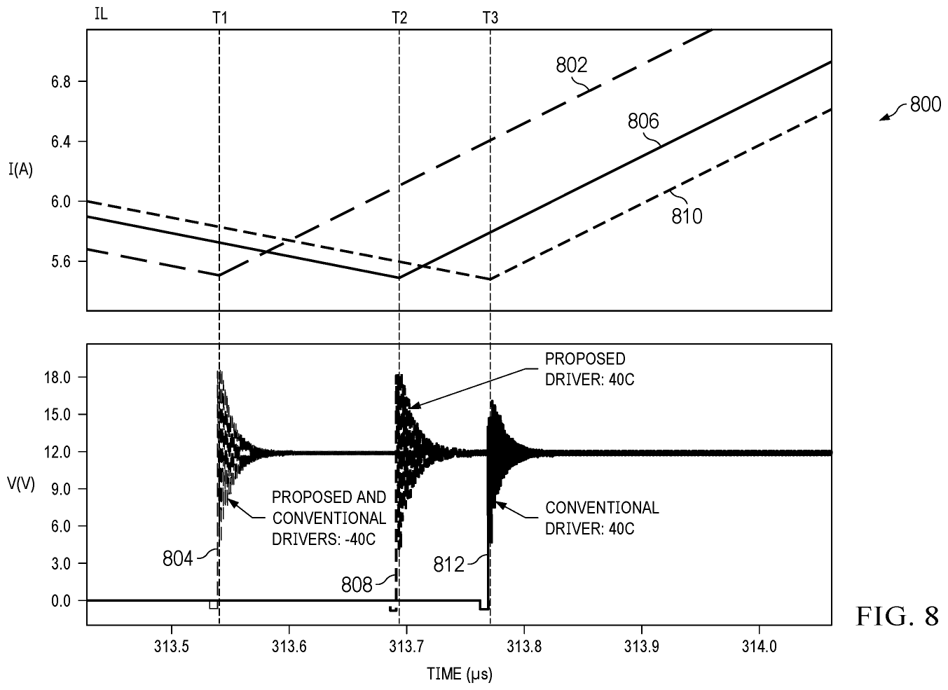

FIG. 8 is a diagram 800 of a comparison of drive strength with and without temperature detection. Waveform 802 depicts an inductor current IL of a switching converter with a conventional driver and a switching converter of FIG. 7 under a same drive mode when the temperature is −40° C. Waveform 804 depicts ringing at the switching terminal SW responsive to the high-side switch turning on at T1 when the temperature is −40° C. Waveform 806 depicts an inductor current IL of a switching converter of FIG. 7 when the temperature is 40° C. Waveform 808 depicts ringing at the switching terminal SW responsive to the high-side switch 714 turning on at T2 when the temperature is 40° C. Waveform 810 depicts an inductor current IL of a switching converter with a conventional driver when the temperature is 40° C. Waveform 812 depicts ringing at the switching terminal SW responsive to the high-side switch 714 turning on at T3 when the temperature is 40° C.

In FIG. 8, when the temperature is −40° C., both a switching converter with a conventional driver and the improved switching converter 702 of FIG. 7 operate under a same drive mode, so ringing amplitudes are the same when the inductor current changes from reducing to increasing, and they do not exceed the breakdown voltage. When the temperature is 40° C., the switching converter with the conventional driver keeps using the same drive mode, and the ringing amplitude gets smaller compared to the ringing amplitude when the temperature is −40° C. However, when the temperature is 40° C., the improved switching converter 702 of FIG. 7 switches to a second drive mode in which additional driver stages increase the slew rate while keep the ringing amplitude under the breakdown voltage. Accordingly, efficiency of the switching converter 702 is improved.

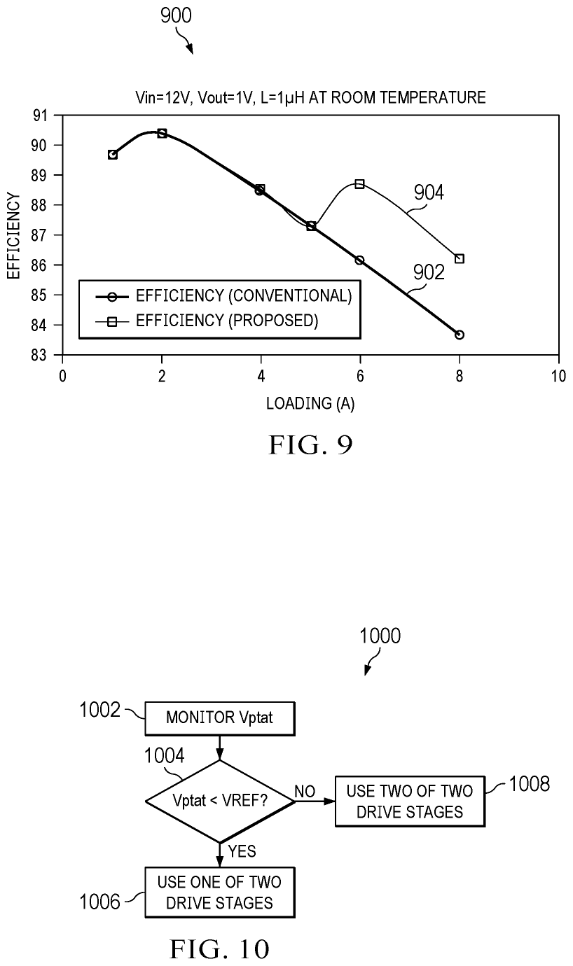

FIG. 9 is a chart 900 of a comparison of efficiency as a function of loading between a conventional drive strategy and the improved drive strategy of the switching converter 702 of FIG. 7. In chart 900, line 902 corresponds to the conventional drive strategy, where efficiency reaches around 90% before dropping as a function of loading to around 84%. Meanwhile, line 904 corresponds to the improved drive strategy, where efficiency reaches around 90% before dropping as a function of loading to around 87% when the loading current is around 5 A, and increases to almost 89% when the loading current increases to around 6 A, and drops as a function of loading to around 86%. In the chart 900, assumed values include VIN=12V, VOUT=1V, and L=1 μH.

FIG. 10 is a flowchart of a switching converter control method 1000 with reference to the system 700 of FIG. 7 in some examples. At step 1002, the temperature detector 712 monitors a signal Vptat representative of a temperature of the switching converter 702. If Vptat is less than a reference voltage VREF representative of a threshold temperature determined at step 1004, one of the first and second drive stages (e.g., the first drive stage 706 of FIG. 7) provides a first drive signal at step 1006. In contrast, if Vptat is greater than or equal to the reference voltage VREF determined at step 1004, both of the first and second drive stages 706 and 708 of FIG. 7 provide a second drive signal at step 1008. In some examples, the method 1000 controls the high-side switch 714 of the switching converter 702. In other examples, the method 1000 controls the low-side switch 716 of the switching converter 702.

In some examples, one or more of the described switching converters (e.g. the switching converter 102 of FIG. 1, or the switching converter 702 of FIG. 7) are useful in a battery-operated device, such as a laptop or tablet. For example, a switching converter is useful in a battery-operated device, where VIN for the switching converter is provided by the battery or an AC/DC adapter. The switching converter reduces VIN to VOUT (e.g. a VIN of 6V or more, and a VOUT of 3.3V or 5V) for use in powering electronic components of the battery-operated device. In other examples, the switching converter increases VIN to VOUT (e.g. a VIN of 5V, and a VOUT of 12V).

In this description, the term “couple” or “couples” means either an indirect or direct wired or wireless connection. Thus, if a first device couples to a second device, that connection may be through a direct connection or through an indirect connection via other devices and connections.

In this description, the recitation “based on” means “based at least in part on.” Therefore, if X is based on Y, then X may be a function of Y and any number of other factors.

In this description, unless otherwise stated, “about,” “approximately” or “substantially” preceding a parameter means being within +1-10 percent of that parameter.

Modifications are possible in the described embodiments, and other embodiments are possible, within the scope of the claims.

What is claimed is:

1. A switching converter comprising:
a controller having a controller input and a controller output, the controller configured to provide: a first mode signal at the controller output responsive to a first temperature signal at the controller input indicating a temperature of the switching converter is lower than a threshold temperature; and a second mode signal at the controller output responsive to a second temperature signal at the controller input indicating the temperature of the switching converter is higher than or equal to the threshold temperature;
drive circuitry having a drive input and a drive output, the drive input coupled to the controller output, and the drive circuitry configured to provide: a first drive signal at the drive output responsive to the first mode signal; and a second drive signal at the drive output responsive to the second mode signal; and
a switch having a control terminal coupled to the drive output.

2. The switching converter of claim 1, wherein the drive circuitry includes first and second drive stages, the first drive stage is configured to provide the first drive signal having a first strength, and the second drive stage is configured to provide the second drive signal having a second strength greater than the first strength.

3. The switching converter of claim 2, wherein the controller comprises a level shifter coupled between the controller input and the second drive stage, in which the level shifter is configured to enable the second drive stage responsive to the second temperature signal at the controller input.

4. The switching converter of claim 1, wherein the drive circuitry includes first and second drive stages, the first drive stage is configured to provide the first drive signal having a first strength, the second drive signal has a second strength and is a combination of the first drive signal and a third drive signal, and the second drive stage is configured to provide the third drive signal having a third strength.

5. The switching converter of claim 4, wherein the controller comprises a level shifter coupled between the controller input and the second drive stage, in which the level shifter is configured to enable the second drive stage responsive to the second temperature signal at the controller input.

6. The switching converter of claim 1, further comprising a temperature sensor having a temperature output coupled to the controller input, the temperature sensor configured to provide: the first temperature signal at the temperature output responsive to the temperature of the switching converter being lower than the threshold temperature; and the second temperature signal at the temperature output responsive to the temperature of the switching converter being higher than or equal to the threshold temperature.

7. The switching converter of claim 6, wherein the temperature sensor includes:
a comparator having a comparator output and first and second comparator inputs, in which the comparator output is the temperature output, and the comparator is configured to provide: the first temperature signal at the comparator output responsive to a signal at the first comparator input indicating the temperature of the switching converter is lower than the threshold temperature, in which the threshold temperature is indicated by a threshold signal at the second comparator input; and the second temperature signal at the comparator output responsive to the signal at the first comparator input indicating the temperature of the switching converter is higher than or equal to the threshold temperature

8. The switching converter of claim 6, further comprising a bandgap voltage generator configured to generate a bandgap voltage, in which the bandgap voltage generator includes the temperature sensor, and the bandgap voltage generator is configured to generate a voltage proportional to a signal at the temperature output.

9. A system comprising:
a temperature sensor having a temperature output, the temperature sensor configured to provide: a first temperature signal at the temperature output responsive to a first temperature at the temperature sensor; and a second temperature signal at the temperature output responsive to a second temperature at the temperature sensor;
a controller having a controller input and a controller output, the controller input coupled to the temperature output, and the controller configured to provide: a first mode signal at the controller output responsive to the first temperature signal; and a second mode signal at the controller output responsive to the second temperature signal;
drive circuitry having a drive input and a drive output, the drive input coupled to the controller output, and the drive circuitry configured to provide: a first drive signal at the drive output responsive to the first mode signal; and a second drive signal at the drive output responsive to the second mode signal; and
a switch having a control terminal coupled to the drive output.

10. The system of claim 9, wherein the drive circuitry includes first and second drive stages, the first drive stage is configured to provide the first drive signal having a first strength, and the second drive stage is configured to provide the second drive signal having a second strength greater than the first strength.

11. The switching converter of claim 10, wherein the controller comprises a level shifter coupled between the controller input and the second drive stage, in which the level shifter is configured to enable the second drive stage responsive to a signal at the controller input indicating any temperature higher than or equal to a threshold temperature.

12. The system of claim 9, wherein the drive circuitry includes first and second drive stages, the first drive stage is configured to provide the first drive signal having a first strength, the second drive signal has a second strength and is a combination of the first drive signal and a third drive signal, and the second drive stage is configured to provide the third drive signal having a third strength.

13. The switching converter of claim 12, wherein the controller comprises a level shifter coupled between the controller input and the second drive stage, in which the level shifter is configured to enable the second drive stage responsive to the signal at the controller input indicating the temperature of the switching converter is higher than or equal to the threshold temperature.

14. The system of claim 9, wherein the first temperature is any temperature lower than a threshold temperature, and the second temperature is any temperature higher than or equal to the threshold temperature.

15. The system of claim 9, wherein the temperature sensor includes:
a comparator having a comparator output and first and second comparator inputs, in which the comparator output is the temperature output, and the comparator is configured to provide: the first temperature signal at the comparator output responsive to a signal at the first comparator input indicating any temperature lower than a threshold temperature, in which the threshold temperature is indicated by a threshold signal at the second comparator input; and the second temperature signal at the comparator output responsive to the signal at the first comparator input indicating any temperature higher than or equal to the threshold temperature.

16. The system of claim 9, further comprising a bandgap voltage generator configured to generate a bandgap voltage, in which the bandgap voltage generator includes the temperature sensor, and the bandgap voltage generator is configured to generate a voltage proportional to a signal at the temperature output.
